(19) United States
(12) Patent Application Publication
(10) Pub. No.: US 2007/0087636 A1
(43) Pub. Date: Apr. 19, 2007

(54) Contact member, connector, substrate and contact system

(75) Inventor: Yasushi Masuda, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/362,837

(22) Filed: Feb. 28, 2006

(30) Foreign Application Priority Data
Oct. 13, 2005 (JP) JP2005-298586

(51) Int. Cl. H01R 9/22; H01R 13/405

(52) U.S. Cl. 439/722; 439/736

(57) ABSTRACT

A pair of contact members 10, 10 coming into contact with both of a front-surface and an undersurface of a substrate 2 by elastic forces, comprise a pair of first contact points 11, 11 getting, when the substrate 2 is inserted, apart from each other due to a thickness of the substrate 2, resisting the elastic forces, and a pair of second contact points 12, 12 coming into, when the pair of first contact points 11, 11 are biased by the elastic forces in such a direction to get close to each other within a hole 21 opened at both of the front-surface and the undersurface of the substrate 2, contact with both of the front-surface and the undersurface of the substrate 2 in a way that interlocks with the first contact points 11,11.

### BACKGROUND OF THE INVENTION

The invention relates to a connector member, a substrate connected by the connector member and a connector system using the connector member.

### BACKGROUND ART

There has hitherto been proposed, for instance, a card edge connector that connects, as between a motherboard and a daughterboard of a computer, a substrate and a substrate to each other (refer to, e.g., Patent document 1).

FIG. 1 shows a construction of a conventional card edge connector 100. In the conventional card edge connector, there was a case in which when a substrate (daughterboard) 107 is inserted in between first contact points 102, 102 of the connector contacts 101, the connector contact 101 cuts the surface of the substrate 107, resulting in occurrence of a foreign matter (cutting chip) 108. If this foreign matter 108 is interposed between a signal terminal 109 and the connector contact 101, a failure in contact might be caused.

Therefore, in the card edge connector 100, one connector contact 101 is provided with a first contact point 102 and a second contact point 103. The first contact point 102 and the second contact point 103 get elastically deformed independently of each other and come into contact with the signal terminals 109, thereby transmitting electric signals. At this time, even if the foreign matter 108 exists on the signal terminal 109 with the result that the contact failure of the first contact point 102 is caused, the second contact 103 is surely brought into electric contact with the signal terminal 109. It is therefore considered that preferable contact reliability can be obtained.

[Patent document 1] Japanese Patent Application Laid-Open Publication No.2001-126791

### SUMMARY OF THE INVENTION

In the prior art described above, the first contact point 102 and the second contact point 103 are provided and get elastically deformed independently of each other, thereby transmitting the electric signals. Consequently, the number of components of the connector contacts 101 increases, and a manufacturing procedure becomes complicated.

It is an object of the invention to provide a contact structure that reduces the contact failure more easily than by the prior arts.

The invention adopts the following means in order to solve the problems. Namely, the invention is contact members that are a pair of contact members coming into contact with both of a front-surface and an undersurface of a substrate by elastic forces, the contact members comprising a pair of first contact points getting apart from each other due to a thickness of the substrate when the substrate is inserted by resisting the elastic forces, and a pair of second contact points coming into contact with both of the front-surface and the undersurface of the substrate in a way that interlocks with the first contact points when the pair of first contact points are biased by the elastic forces in such a direction to get close to each other within a hole opened at both of the front-surface and the undersurface of the substrate.

According to the invention, till the pair of first contact points are biased by the elastic forces in such a direction as to get close to each other within the hole opened at both of the front-surface and the undersurface of the substrate, the second contact points keep the state of getting apart from each other. Accordingly, even when the first contact points cut the surfaces of the substrate, such a possibility is small that a cut-off substance might be pinched in between the second contact points. Hence, when the second contact points come into contact with both of the front-surface and the undersurface of the substrate while interlocking with the first contact points, there is decreased such a situation that the substance is squeezed in between the contact portions thereof.

Further, the invention may be a connector comprising a housing, and a pair of contact members assembled into the housing and coming into contact with both of a front-surface and an undersurface of a contactee substrate by elastic forces, wherein the contact members include a pair of first contact points getting apart from each other due to a thickness of the contactee substrate when the contactee substrate is inserted by resisting the elastic forces; and a pair of second contact points coming into contact with both of the front-surface and the undersurface of the contactee substrate in a way that interlocks with the first contact points when the pair of first contact points are biased by the elastic forces in such a direction to get close to each other within a hole opened at both of the front-surface and the undersurface of the contactee substrate.

According to the invention, the connector assembled with the contact members is constructed, whereby contact reliability with the contactee substrate can be enhanced.

Still further, the invention may be a substrate comprising a substrate member, a housing fixed to the substrate member, and a pair of contact members assembled into the housing and coming into contact with both of a front-surface and an undersurface of a contactee substrate by elastic forces, wherein the contact members include a pair of first contact points getting apart from each other due to a thickness of the contactee substrate by resisting the elastic forces when the contactee substrate is inserted, and a pair of second contact points coming into contact with both of the front-surface and the undersurface of the contactee substrate in a way that interlocks with the first contact points when the pair of first contact points are biased by the elastic forces in such a direction to get close to each other within a hole opened at both of the front-surface and the undersurface of the contactee substrate.

According to the invention, the substrate assembled with the connector is constructed, whereby the contact reliability with the contactee substrate can be enhanced.

Yet further, the invention may be a connector system comprising a first substrate and a second substrate, the first substrate including a substrate member, a housing fixed to the substrate member, and a pair of contact members assembled into the housing and coming into contact with both of a front-surface and an undersurface of the second substrate by elastic forces, the contact members including a pair of first contact points getting apart from each other due to a thickness of the second substrate when the second substrate is inserted by resisting the elastic forces, and a pair of second contact points coming into contact with both of the front-surface and the undersurface of the second substrate in a way that interlocks with the first contact points when the pair of first contact points are biased by the elastic forces in such a direction to get close to each other within a hole opened at both of the front-surface and the undersurface of the second substrate, the second substrate including a substrate member having a predetermined thickness and separating the pair of first contact points due to the predetermined thickness thereof when inserted in between the pair of first contact points by resisting the elastic forces, conductive portions formed on the front-surface and the undersurface of the substrate member, against which the second contact points are pressed, and a hole formed so as to be opened at both of the front-surface and the undersurface in a position apart by a distance corresponding to a distance between the first point and the second point from the conductive portion.

According to the invention, the first substrate assembled with the connector is constructed, whereby the contact reliability with the second substrate can be enhanced.

Preferably, the hole may be formed so as to penetrate the second substrate. Further, preferably, the hole may also be a cavity formed in at least one of the front-surface and the undersurface in positions corresponding to each other on the front surface and the undersurface of the second substrate.

According to the invention, the contact failure can be reduced with a simpler construction than in the prior arts.

### BRIEF DESCRIPTION OF THE DRAWINGS

FIG. 1 is a view showing a construction of a card edge connector 100 in the prior art;

FIG. 2 is a perspective view of a substrate component including a card edge connector according to one embodiment of the invention;

FIG. 3 is a sectional view of the substrate component including the card edge connector;

FIG. 4 is an explanatory view (before a fitted state) of a procedure of fitting the substrate to the card edge connector;

FIG. 5 is an explanatory view (a state where a substrate edge portion comes into contact with contacts) of a procedure of fitting the substrate to the card edge connector;

FIG. 6 is an explanatory view (a state where first contact points come into contact with the contacts) of a procedure of fitting the substrate to the card edge connector;

FIG. 7 is an explanatory view (a state where the contacts are positioned between the first contact points and second contact points) of a procedure of fitting the substrate to the card edge connector;

FIG. 8 is an explanatory view (a state where the first contact points reach a hole) of a procedure of fitting the substrate to the card edge connector;

FIG. 9 is an explanatory view (a state where the fitting of the substrate is completed) of a procedure of fitting the substrate to the card edge connector;

FIG. 10 is a sectional view of the substrate component according to a modified example of the invention;

### DETAILED DESCRIPTION OF THE INVENTION

A card edge connector 1 according to a best mode (which will hereinafter be termed an embodiment) for carrying out the invention will hereinafter be describe with reference to the drawings. A configuration in the following embodiment is an exemplification, and the invention is not limited to the configuration in the embodiment.

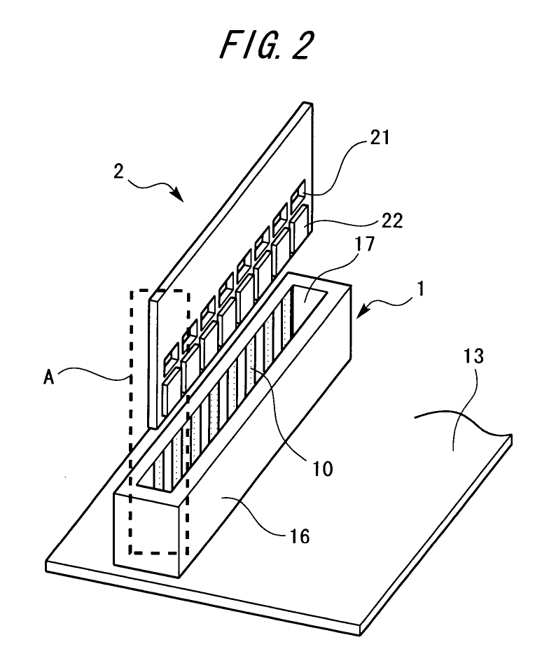

FIG. 2 is a perspective view of a substrate component (corresponding to a connector system according to the invention) including the card edge connector 1 according to one embodiment of the invention. This substrate component is constructed of a first substrate 13 (corresponding to a substrate and a first substrate according to the invention) fitted with the card edge connector 1, and a second substrate 2 (corresponding to a second substrate according to the invention) connected to the first substrate 13 by the card edge connector 1.

The first substrate 13 is, e.g., a motherboard. The card edge connector 1 is fixed by soldering etc to the first substrate 13. The card edge connector 1 includes a housing 16, and an upper portion (which is the upper portion as viewed in FIG. 2) of the housing 16 is formed with an opening 17 into which the second substrate 2 can be inserted. Further, contacts 10 (corresponding to contact members according to the invention) are arrayed along an inside surface of the opening 17. The card edge connector 1 is soldered to the first substrate 13, whereby the contacts 10 are connected to an unillustrated conductive pattern on the first substrate.

The second substrate 2 is, e.g., a daughterboard fitted to the motherboard. The second substrate 2 has gold pads 22 (corresponding to conductive portions according to the invention) on both surfaces (a front-surface and an undersurface) of the substrate member inserted into the opening 17 of the first substrate 13. The pad 22 is a substantially rectangular pattern formed on the second substrate 2 and is connected to the unillustrated conductive pattern on the second substrate 2. It should be noted that the pad 22 is not limited to the rectangular pattern and may not cause any inconvenience by taking a polygonal pattern, a circular pattern, an elliptical pattern and so on.

When the second substrate 2 is inserted into the card edge connector 1, the pads 22 are brought into contact with the corresponding contacts 10 within the card edge connector 1. Through this operation, the conductive pattern on the second substrate 2 is connected to the conductive pattern on the first substrate 13 via the card edge connector 1.

A characteristic of this substrate component lies in that the second substrate 2 is provided with a line (train) of holes 21 in such a position that the pads 22 are nestled between the contacts 10 and an edge portion as viewed from the edge portion of the substrate. The train of holes 21 is formed in parallel with a train of pads 22.

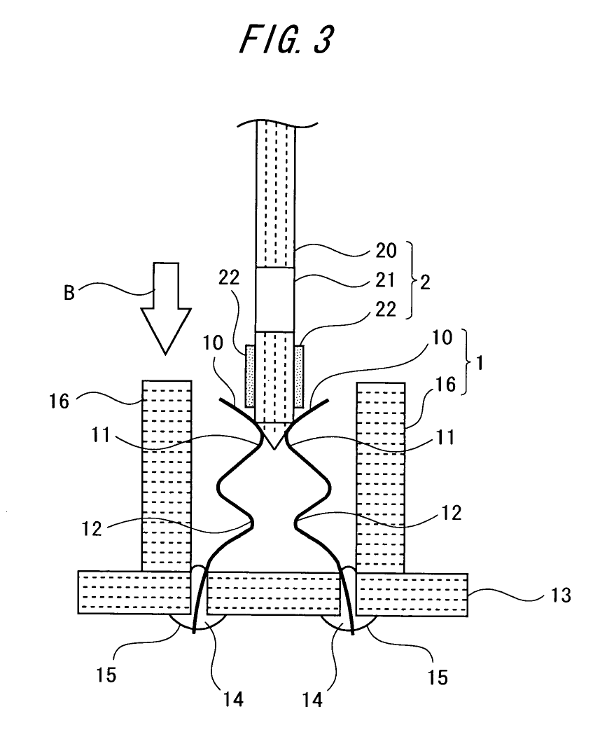

FIG. 3 is a sectional view of the substrate component cut off along a plane A depicted by a dotted line in FIG. 2. In FIG. 3, however, the depiction is given in a state where the substrate edge portion of the second substrate 2 moves down to a position of abutting on the contacts 10.

The contacts 10 are fixed by unillustrated fixing members to the housing 16 of the card edge connector 1. On the other hand, the contacts 10 are inserted into holes 14, 14 on the first substrate 13 and soldered to the unillustrated conductive pattern. As a result, the card edge connector 1 is fixed to the first substrate 13, and the contacts 10 are connected to the unillustrated conductive pattern of the first substrate 13.

As shown in FIG. 3, the contacts 10 have two curved portions in face-to-face positions. The respective curved portions function as a first contact point 11 and a second contact point 12 when the second substrate 2 is inserted.

The substrate edge portion of the second substrate 2 is cut with two facets making a predetermined angle to facilitate the insertion in between the contacts 10. This angle may be, if smaller than 180 degrees (a flat surface), an acute angle and an obtuse angle. The substrate edge portion does not necessarily need sharpening, and there may not be caused any inconvenience by simply chamfering the substrate edge portion to such a degree as to facilitate the insertion in between the contacts 10. Further, the substrate edge portion may also be formed in a roundish curved shape.

As illustrated in FIG. 3, the pads 22, 22 are formed inwardly of the substrate edge portion (in upward positions from the substrate edge portion in FIG. 3) in the two surfaces (which are referred to also as a front-surface and an undersurface) of the second substrate 2. Moreover, the holes 21 are formed in positions (which are upward positions in FIG. 3) advancing inwards along the substrate surface. A positional relationship between the hole 21 and the pad 22 corresponds to a positional relationship between the first contact point 11 and the second contact point 12. Namely, the second substrate 2 is inserted in between the contacts 10, and, when the first contact point 11 reaches the position of the hole 21, the second contact point 12 is brought into contact with the pad 22. As the contacts 10 are fixed to the housing 16, the first contact points 11, 11 reach the hole 21, while the second contact points 12, 12 press the second substrate 2 through the pads 22, and the second substrate 2 is held within the card edge connector 1, thus keeping the contacts between the contacts 10, 10 and the pads 22, 22 through the second contact points 12, 12.

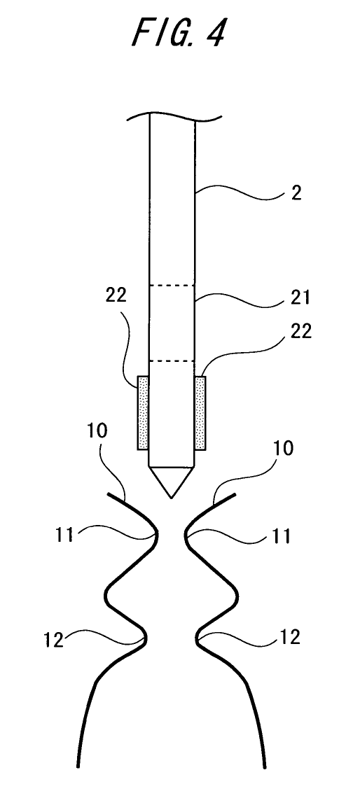

A procedure of attaching the second substrate 2 to the card edge connector 1 will be explained with reference to FIGS. 4 through 9. In FIGS. 4 through 9, however, the first substrate 13 and the card edge connector 1 are omitted, and only the contacts 10 are explicitly illustrated. FIG. 4 shows a state before inserting the second substrate 2 in between the contacts 10 of the card edge connector 1.

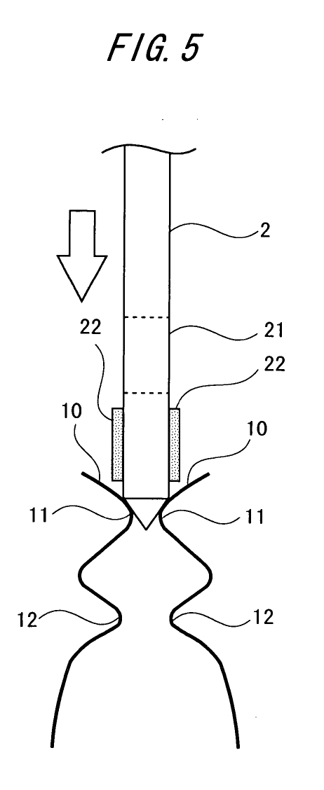

Next, FIG. 5 illustrates a state where the substrate edge portion of the second substrate 2 abuts on the contacts 10. When the second substrate 2 is inserted gradually from its substrate edge portion in between the contacts 10, the surfaces of the second substrate 2 are cut by the contact members in the vicinity of the first contact points 11, 11, resulting in occurrence of chips. These chips drop down between the contacts 10 or are squeezed through between the first contact points 11, 11 and the surfaces (the front-surface and the undersurface) of the second substrate 2. Hereat, the second contact points 12, 12 of the contacts 10 are kept apart from each other, and hence the dropping chips are not caught in by the second contact points 12, 12.

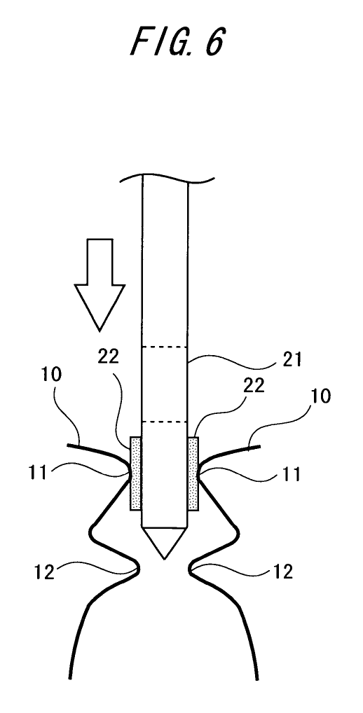

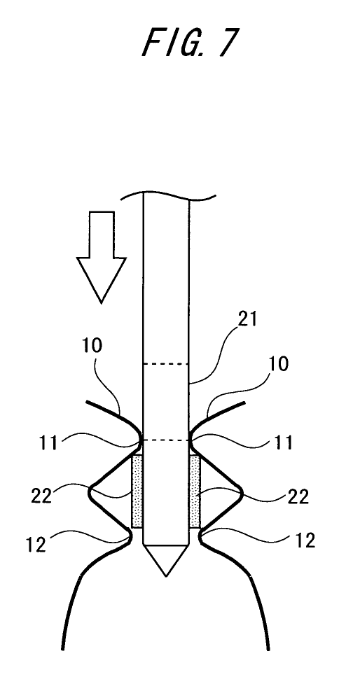

FIG. 6 illustrates a state in which the second substrate 2 is inserted deeper, and the pads 22, 22 come into contact with the first contact points 11, 11. FIG. 7 shows a state in which the second substrate 2 is inserted much deeper, and the pads 22, 22 are positioned between the first contact points 11, 11 and the second contact points 12, 12. In this state, the first contact points 11, 11 do not yet reach the position of the hole 21. Further, the second contact points 12, 12 do not yet come into contact with the pads 22, 22.

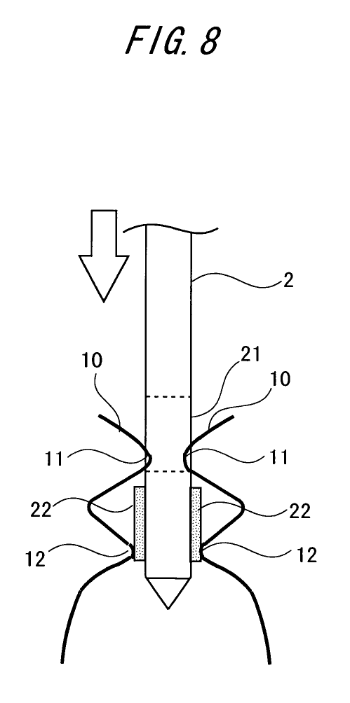

FIG. 8 illustrates a state in which the second substrate 2 is inserted even deeper, and the first contact points 11, 11 of the contacts 10, 10 reach the position of the hole 21. In this state, the first contact points 11, 11 are biased in such a direction as to get close to each other by elastic forces of the contacts 10, 10 within the hole 21. As a result, the contacts 10, 10 get close to each other. To be specific, the second contact points 12, 12 are pressed against the pads 22, 22 on the front-surface and the undersurface of the second substrate 2 by the elastic forces of the contacts 10, 10 while interlocking with the first contact points 11, 11. At this time, the second contact points 12, 12 are kept in such a state just before being pressed as to be separated from the surfaces of the second substrate 2. Then, when the first contact points 11, 11 enter the hole 21, the second contact points 12, 12 are pressed against the pads 22, 22 on the front-surface and the undersurface of the second substrate 2 by the elastic forces of the contacts 10, 10. Accordingly, the second contact points 12, 12 have a low possibility of coming into contact with the surfaces of the second substrate 2 till being pressed against the pads 22, 22 and therefore have a less possibility of cutting the surfaces of the second substrate 2.

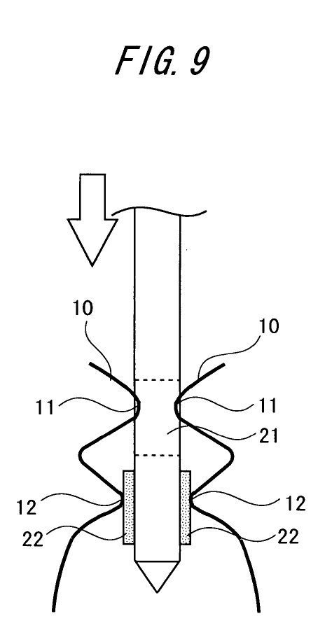

FIG. 9 shows a state where the second substrate 2 is inserted by far deeper, and the insertion of the second substrate 2 is completed. Namely, the state is such that the first contact points 11, 11 of the contacts 10, 10 reach the an upper portion (which is a portion positioned upwards as viewed in FIG. 9) of the hole 21. In this state, the first contact points 11, 11 and the upper edge portion of the hole 21 function as a stopper, whereby the second substrate 2 comes to a state of being unable to get inserted farther. In this state, the first contact points 11, 11 do not come into contact with the conductive pattern on the second substrate 2. While on the other hand, the second contact points 12, 12 keep the state of being in contact with the pads 22, 22.

As described above, according to the card edge connector 1 in the embodiment, when the edge portion of the second substrate 2 is inserted in between the first contact points 11, 11, the first contact points 11, 11 get apart from each other due to the thickness of the second substrate 2, resisting the elastic forces. As a result, the second contact points 12, 12 get apart from each other farther than before the second substrate 2 is inserted in between the first contact points 11, 11. Therefore, the first contact points 11, 11 slide on the surfaces of the second substrate 2 and thus cut the surfaces of the second substrate 2 with the result that the cutting chips occur, even in which case the chips are accumulated in between the first contact points 11, 11 and the surfaces of the second substrate 2 or drop down between the contacts 10, 10. Accordingly, such a possibility is small that the chips occurred by the first contact points 11, 11 sliding on the surfaces of second substrate might be squeezed in between the second contact points 12, 12.

Then, the first contact points 11, 11, when reaching the hole 21 opened at both of the front-surface and the undersurface of the second substrate 2, are biased by the elastic forces of the contacts 10, 10 in such a direction as to get close to each other. Hereat, the second contact points 12, 12 come into contact with the pads 22, 22 on the front-surface and the undersurface of the second substrate 2 by the elastic forces of the contacts 10, 10 while interlocking with the first contact points 11, 11. In this case, the second contact points 12, 12 do not slide on the surfaces of the second substrate 2 just before the second contact points 12, 12 come into contact with the pads 22, 22. Therefore, such a possibility is small that the chips occurred by the contacts 10, 10 sliding on the surfaces of the second substrate 2 might turn out to be foreign matters and might be squeezed in between the second contact points 12, 12 and the pads 22, 22. Hence, the second contact points 12, 12 and the pads 22, 22 can acquire preferable contact reliability. Namely, the preferable contact can be obtained with a simple construction of assembling the contacts 10, 10 each having two curved portions into the housing 16.

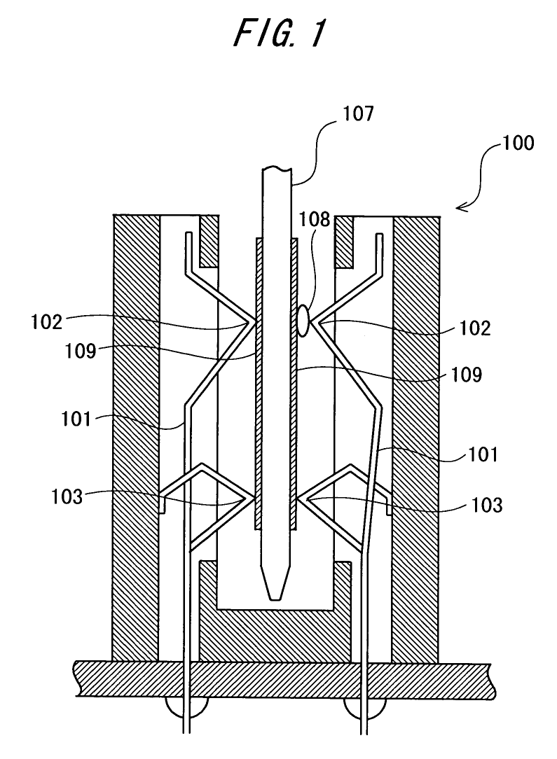

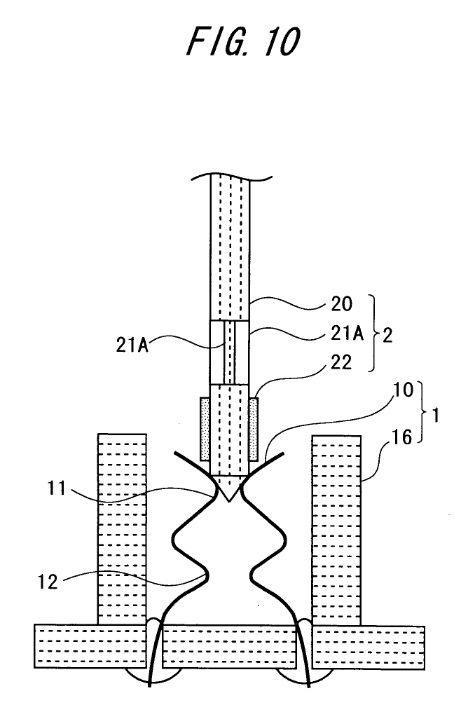

By the way, the embodiment takes the construction that the second substrate 2 is provided with the hole 21 opened therein, and the first contact points 11, 11 are biased by elastic forces of the contacts 10, 10 in such a direction as to get close to each other. The embodiment of the invention is not, however, limited to this construction. Namely, as shown in FIG. 10, in place of the hole 21 penetrating the surfaces throughout, cavities (not-hollowed recessed portions) 21A, 21A may be provided in the front-surface and the undersurface of the second substrate 2. To be specific, a construction may be contrived such that the first contact points 11, 11 drop down onto the cavities 21A, 21A, whereby the second contact points 12, 12 come into contact with the pads 22, 22 on the front-surface and the undersurface of the second substrate 2 by dint of the elastic forces of the contacts 10, 10 while interlocking with the first contact points 11, 11. This construction also enables the card edge connector 1 to function in the same way as in the cases illustrated in FIGS. 1 through 9.

Further, the cavity (21A or 21B) may be formed in at least one of the front-surface and the undersurface in positions corresponding to each other on the front surface and the undersurface of the second substrate 2.

<Others>

The disclosures of Japanese patent application No.JP2005-298586 filed on Oct. 13, 2005 including the specification, drawings and abstract are incorporated herein by reference.

What is claimed is:

1. Contact members being a pair of contact members that come into contact with both of a front-surface and an undersurface of a substrate by elastic forces, comprising:
a pair of first contact points getting apart from each other due to a thickness of said substrate when said substrate is inserted by resisting the elastic forces; and
a pair of second contact points coming into contact with both of the front-surface and the undersurface of said substrate in a way that interlocks with said first contact points when said pair of first contact points are biased by the elastic forces in such a direction to get close to each other within a hole opened at both of the front-surface and the undersurface of said substrate.

2. A connector comprising:
a housing; and
a pair of contact members assembled into said housing and coming into contact with both of a front-surface and an undersurface of a contactee substrate by elastic forces,
wherein said contact members include a pair of first contact points getting apart from each other due to a thickness of said contactee substrate when a contactee substrate is inserted by resisting the elastic forces; and
a pair of second contact points coming into contact with both of the front-surface and the undersurface of said contactee substrate in a way that interlocks with said first contact points when said pair of first contact points are biased by the elastic forces in such a direction to get close to each other within a hole opened at both of the front-surface and the undersurface of said contactee substrate.

3. A substrate comprising:
a substrate member;
a housing fixed to said substrate member; and
a pair of contact members assembled into said housing and coming into contact with both of a front-surface and an undersurface of a contactee substrate by elastic forces,
wherein said contact members include a pair of first contact points getting apart from each other due to a thickness of said contactee substrate when the contactee substrate is inserted by resisting the elastic forces; and
a pair of second contact points coming into contact with both of the front-surface and the undersurface of said contactee substrate in a way that interlocks with said first contact points when said pair of first contact points are biased by the elastic forces in such a direction to get close to each other within a hole opened at both of the front-surface and the undersurface of said contactee substrate.

4. A connector system comprising:
a first substrate and a second substrate;
said first substrate including:
a substrate member;
a housing fixed to said substrate member; and
a pair of contact members assembled into said housing and coming into contact with both of a front-surface and an undersurface of said second substrate by elastic forces,
said contact members including:
a pair of first contact points getting apart from each other due to a thickness of said second substrate when said second substrate is inserted by resisting the elastic forces; and
a pair of second contact points coming into contact with both of the front-surface and the undersurface of said second substrate in a way that interlocks with said first contact points when said pair of first contact points are biased by the elastic forces in such a direction to get close to each other within a hole opened at both of the front-surface and the undersurface of said second substrate,
said second substrate including:
a substrate member having a predetermined thickness and separating said pair of first contact points due to the predetermined thickness thereof by resisting the elastic forces when inserted in between said pair of first contact points;
conductive portions formed on a front-surface and an undersurface of said substrate member, against which said second contact points are pressed; and
a hole formed so as to be opened at both of the front-surface and the undersurface in a position apart by a distance corresponding to a distance between said first point and said second point from said conductive portion.

5. The connector system according to claim 4 wherein the hole is formed so as to penetrate the second substrate.

6. The connector system according to claim 4 wherein the hole is a cavity formed in at least one of the front-surface and the undersurface in positions corresponding to each other on the front surface and the undersurface of the second substrate.
